(19) United States
(12) Patent Application Publication
(10) Pub. No.: US 2011/0196742 A1
(43) Pub. Date: Aug. 11, 2011

(54) METHOD TO DRIVE A CAMPAIGN WORKFLOW BASED ON A SHORT MESSAGE SERVICE (SMS) MESSAGE RESPONSE

(75) Inventors: Sujai Karnam Holal, Karnataka (IN); Doddamane Gururaja, Karnataka (IN); Amit Kamath Narasimha, Karnataka (IN); Mahesh Sahu Kumar, Karnataka (IN)

(73) Assignee: TALISMA CORPORATION PRIVATE LTD., Sadashivanagar Bangalore, KA (IN)

(21) Appl. No.: 13/059,013

(22) PCT Filed: May 18, 2009
(86) PCT No.: PCT/IB09/52061

§ 371 Date: Apr. 29, 2011

(30) Foreign Application Priority Data
Aug. 14, 2008 (IN) 1979/CHE/2008

(51) Int. Cl. G06Q 30/00

(52) U.S. Cl. 705/14.54

(57) ABSTRACT

A method to generate and transmit appropriate Actions for different customers based on their response to a marketing Campaign in a CRM application includes receiving a communication event (via SMS message, email message, instant message and the like) from the customer with Internal ID (internal identifier) embedded inside the content of the communication event, searching for the Internal ID inside the communication event, extracting keyword and substring from the searched Internal ID, threading communication event to corresponding pre-existing Interaction Thread same Interaction ID wherein a new Interaction Thread is started, for which there is no pre-existing Interaction Thread with same Interaction ID, identifying Event ID, Interaction ID and Campaign Step Code from the keyword and the substring, linking interaction to identified Campaign Step with respect to which the customer has sent the communication event, generating appropriate reply action based on the campaign step, transmitting action to the customer.

### TECHNICAL FIELD

The invention relates to a method to drive a Campaign Workflow based on an SMS message response in a Customer Relationship Management (CRM) application. In particular, the invention relates to a method and system to generate and transmit appropriate Actions for different customers, based on their response to a marketing Campaign, in a CRM application.

### BACKGROUND ART

Customer Relationship Management system consists of the processes a company uses to track and organize its contacts with its current and prospective customers. CRM application is used to support these processes; the software system can be accessed and information about customers and customer interactions can be entered, stored and accessed by employees in different departments of the company. Typical CRM goals are to improve services provided to customers and to use customer contact information for targeted marketing.

Marketing Campaign is a series of organized marketing efforts achieved through advertising using a public platform such as email, SMS, newspaper etc. Marketing Campaigns enable organizations, companies and institutions to manage communication plans and conduct automated closed-loop Campaigns, newsletters, and surveys that develop awareness, generate prospect leads, and proactively communicate with prospects and constituents in a personalized one-to-one manner. During such Campaigns, a series of messages are sent to the existing or prospective customer. In a CRM application, each campaign may include multiple campaign items: alerts, offers, discounts, or direct mail messages etc. All campaign items within one campaign have a common customer and date ranges. The Campaign Manager module in CRM application creates and schedules marketing campaigns and delivers targeted content to its customers. For example, a campaign may be created for advertisements, discounts, alters or direct mail. A company may target ads or discounts to the users of a specific profile. Campaigns may also be analyzed, giving the CRM user an ability to make decisions about pricing, targeting content, and other aspects of the business. Typically, the contacts are called as ‘targets’ of a Campaign (a target record is created for a contact every time he or she is ‘targeted’ for a Campaign). Generally, a Campaign Workflow may consist of various components such as ‘Action Node’ to assign an Action, ‘Add event’ to track different contact Actions such as whether the user clicked a particular URL or whether he responded to the campaign, ‘Wait event’ to wait for the designated number of hours or days and ‘Connectors’ to connect the Actions and/or events together. In a Campaign Workflow, an Event triggers the Action that follows it. Various Actions may be defined for each event, based on the response of customers e.g. creating opportunity on positive response to mailer (or e-mail), sending the same mailer if there is no response for a predefined period, track URL click etc. Actions may be either to initiate a call, send an e-mail, send a reply SMS message, move to a different campaign, and set the values for a Property and the like. When a Campaign that includes an Action to send SMS message, is processed, the SMS messages are dispatched to the targets that progress to the send SMS message Action in the Campaign Workflow. The content of the SMS message is received by the target through the corresponding SMS Service Provider selected in the corresponding Event.

### DISCLOSURE OF INVENTION

### Technical Problem

SMS Marketing Campaign through CRM application plays a vital role in maintaining and developing relationships with the existing clients. Most of the CRM applications available today support the transmission of bulk SMS Messages constituting a Marketing Campaign and many of them perform a standard Action on receiving a response to an SMS message. With the existing techniques it is not possible to have a different set of Actions for an SMS message, performed through different types of campaigns in CRM application. The disadvantage of the existing systems is that if a customer responds to a Campaign using the SMS medium, the message is treated as a normal message and will have a standard response mechanism irrespective of requirements of the customer. Even within the same Campaign Module, organizations generally need the flexibility to design and configure various Actions based on different response types such as an SMS response for an option to receive offers and information, call back, more information, not interested, spam, pull personal information like application status, account balance, etc.

Hence what is needed is a system and method that can generate and transmit appropriate Action for different customers and provide them with relevant replies depending upon their queries and requests.

### Technical Solution

The present invention addresses one or more of the above mentioned problems, as well as possibly addressing other problems as well. The invention provides a method, system and a computer program product to generate and transmit appropriate Actions for different customers based on their response to a marketing Campaign in a CRM application.

Thus according to one aspect of the invention, a method to generate and transmit appropriate Actions for different customers based on their response to a marketing campaign in a CRM application includes receiving a communication event (via SMS message, email message, instant message and the like) from the customer with Internal ID (internal identifier) embedded inside the content of the communication event, searching for the Internal ID inside the communication event, extracting keyword and substring from the searched Internal ID, threading the communication event to corresponding pre-existing Interaction Thread with same Interaction ID wherein a new Interaction Thread is started, for which there is no pre-existing Interaction Thread with same Interaction ID, identifying Event ID, Interaction ID and Campaign Step Code from the keyword and the substring, linking interaction to identified Campaign Step with respect to which the customer has sent the communication event, generating appropriate reply Action based on the Campaign Step, transmitting the reply action to the customer.

According to another aspect of the invention, a customer relationship management system includes a centralized customer database configured to store customer data (comprising name, organization, phone number, email ID, address and the information associated with the customer); centralized communication database interlinked with the customer database; a marketing campaign module configured to analyze the communication events and based on the analysis generate appropriate actions while running the campaign, a user interface window on CRM application displaying the marketing campaign module in graphical form.

According to one more aspect of the invention, the customer relationship management system further includes a graphical workflow wherein pre-determined actions are generated automatically by the customer relationship management system, depending upon the response from the customer.

According to yet another aspect of the invention, a computer program product is provided that is tangibly embodied on an information carrier, such as a computing device memory. The computer program product comprises program instructions that when executed, perform the above methods of generating and transmitting appropriate Actions for different customers based on their response to a marketing Campaign in a CRM application.

### Advantageous Effects

The invention has the ability to generate and transmit an appropriate Action as a response to a Marketing Campaign that gives greater flexibility in the automation of Actions that can be modeled within a Campaign Workflow. This helps in achieving a closer integration between SMS Messaging and Marketing Campaigns and have different Workflows based on the response to a specific Campaign Step. By using this invention, an organization can automate a Campaign Action based on the SMS message response and link these responses with the Campaign, which can further be used for Statistical Data Analysis. The invention also gives complete flexibility and automation to an organization running the Marketing Campaign. The Campaign Workflows can be designed for the entire year with automated response management, engagement, offers, call back, follow-up, reminders etc. through a What You See Is What You Get (WYSIWYG) flow chart type of user interface where various flows could be designed in an easy way. Based on the SMS message response, the target contacts could flow through the Campaign Workflow that contains various Action steps. Each step could have an Action based on the response from the customers.

Other features of the invented method will be apparent from the accompanying drawings and from the detailed description that follows.

### DESCRIPTION OF DRAWINGS

In the drawings, preferred embodiments of the invention are illustrated by way of example. It is to be expressly understood that the description and drawings are only for the purpose of illustrations and as an aid to understanding and are not intended as a definition of the limits of the invention.

FIG. 1 illustrates the functional block diagram of operating environment in which SMS message is exchanged between a computing device and a mobile device.

FIG. 2 is a block diagram of the Customer Relationship Management System embodying the principles of the present invention.

FIG. 3 is a process flow illustrating one approach of processing an interaction when initiated by the customer with the organization in accordance with one embodiment of the invention.

FIG. 4 is a process flow illustrating one approach of generating and transmitting appropriate Action upon receiving response from the customer for a particular Campaign in accordance with one embodiment of the invention.

FIG. 5 is an exemplary diagram of a suitable computing system environment in which illustrative embodiments of the invention may be implemented.

### BEST MODE

Embodiments of the present invention provide a method, system and a computer program product to drive a Campaign Workflow based on an SMS message response in a CRM application. While the invention has been particularly shown and described with reference to an illustrative embodiment, it will be understood by those skilled in the art that various changes in the form and detail may be made therein without departing from the spirit and soul of the invention.

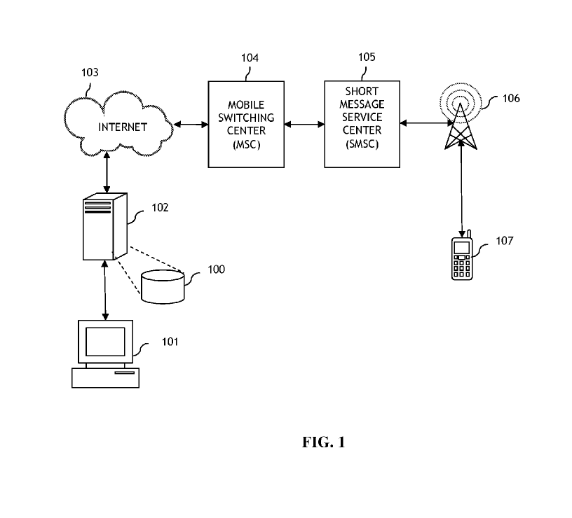

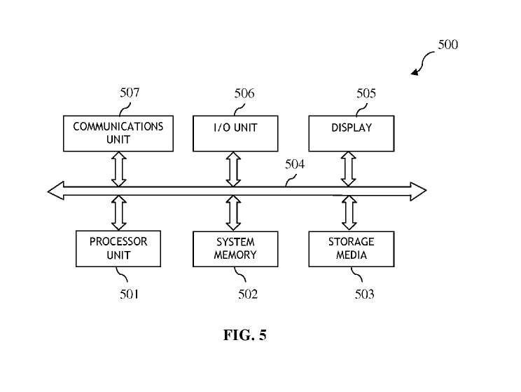

FIG. 1 is a functional block diagram of the operating environment in which SMS messages are exchanged between a Computing Device 101 and a Mobile Device 107. An exemplary Mobile Device 107 is shown as being in wireless communication with the Computing Device 101 running the CRM application. Text messages are exchanged between Mobile Device 107 and Computing Device 101, through Application Server 102. An Application Server 102 is a program that handles all application operations between users and an organization's backend business applications or databases. An Application Server 102 makes applications available to multiple concurrent users across the network. Application Server contains the Database 100 embodying Customer Database and Communication Database. The CRM application embodying the present invention is operational with numerous other general purpose or special purpose Computing System environments or configurations. Examples of well known computing systems, environments, and/or configurations that may be suitable for implementation or use for the purpose of the invention includes, and not limited to personal computer, desktop or a server computer, laptops which run on any one of the following operating systems, Windows Server 2003, Windows XP or Windows Vista. To access the CRM application over the web, interne browsers like Internet Explorer and Firefox browsers are supported. SMS messages may also be transmitted between messaging devices that do not include mobile device. Mobile Device network includes a Wireless Transceiver Station 106 that communicates with the mobile device network via wireless link. Short message channel includes a Short message Service Center (SMSC) 105 that is networked to the Mobile Switching Center (MSC) 104. The Mobile Switching Center 104 connects telephone calls by switching the digital voice data packets from one network path to another (also called routing). The Mobile Switching Center 104 also provides the information that is needed to support mobile service subscribers, such as user registration and authentication information, etc. Short message Service Center 105 directs Short Messages (SMS) between Mobile Device 107 and text messaging device via computer network according to the present invention. It will be appreciated that Mobile Switching Center 104 and Short message Service Center 105 may be implemented with one or more specialized or general-purpose computer systems. Such a system (described below with reference to FIG. 5) commonly include a high-speed processing unit (CPU) in conjunction with a memory system (with volatile and/or non-volatile memory), an input device and an output device as is known in the art. The communication events may include SMS messages both sent and received, e-mail correspondences both sent and received and two-way chatting etc. Each such communication generally includes two parties or users at each end. In context of the present invention, one user is referred to as a Customer who may be a prospective customer, a new customer or an old customer. The user on the other end may be a Computing Device or marketing department personals who initiated the Campaign. Customer contact data is stored inside the Customer Database whereas all the interactions containing communication events are stored in the Communication Database. The terms Customer, Customer Database, and Communication Database are used throughout the detailed description of the invention to enable an easy understanding of the invented method.

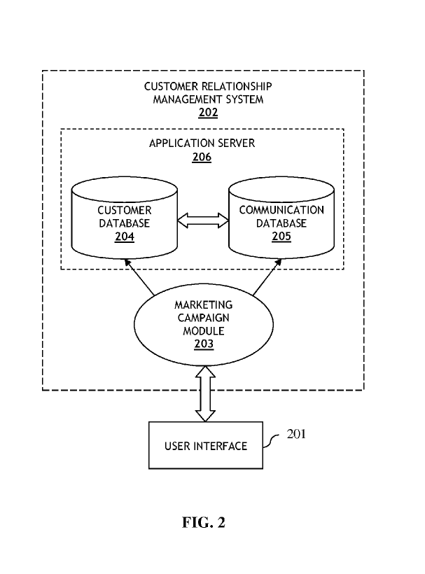

With reference to FIG. 2, a block diagram of Customer Relationship Management System 202 is depicted in accordance with one embodiment of the invention. The block diagram illustrates a Marketing Campaign Module 203, a Customer Database 204, a Communication Database 205, an Application Server 206 (storing both the Customer Database 204 and Communication Database 205) and a User Interface 201 according to one embodiment of the invention. The Marketing Campaign Module 203 is configured to retrieve and analyze information from both the Customer Database 204 as well as the Communication Database 205 through the Application Server 206. The Customer Database 204 may be configured to store the customer information such as name, organization, phone number, address, email ID etc. The Communication Database 205 may be a database configured to store all the Interaction threads containing all the communication events exchanged with the customer. The marketing campaign module is configured to analyze the communication events and based on the analysis generates appropriate actions while running the campaign. When a new Communication Event is received from the customer, an Internal ID (Internal Identifier) is generated by the Marketing Campaign Module 203 that may contain information about the type of communication (e.g. interaction, campaign, subscription etc) and other details (e.g. Communication Event Identifier, Interaction Identifier, Campaign Step with respect to which the communication was received from the customer). The information about the Communication Event, Interaction and Campaign Step is retrieved from the Internal ID inside the reply SMS message text. The Marketing Campaign Module 203 may generate and transmit an appropriate Action in the exemplary embodiment, based on the Campaign Step from where the message was initially sent to the customer during a Marketing Campaign and transmits the message to the customer in order to fulfill his requirements. In the example embodiment illustrated in FIG. 2, the Marketing Campaign Module 203 communicates with the Customer Database 204 and the Communication Database 205 through the Application Server 206. The User Interface 201 displays said marketing campaign module in graphical form on the screen of the computing device. The information includes the Customer information (retrieved from the Customer Database 204) and all the communication events or interactions between the Customer and the entity (retrieved from the Communication Database 205) along with the general features of the CRM application.

According to one embodiment of the present invention, Customer Relationship Management System includes a Customer Database 204 (FIG. 2) configured to store the Customer Data (e.g. name, organization, phone number, email ID, address and any other fields associated with the customer). All communication events including messages originating from or received by the Computing Device 500 (FIG. 5), and all other Communications Events accessible to the Computing Device 500 (FIG. 5) are stored in Communications Database 205 (FIG. 2). Both the databases are preferably integrated with the Computing Device 500 (FIG. 5) running CRM application, though it is fully contemplated that a database may reside in an Application Server 206 (FIG. 2) and be accessed through network connections by remote Computing Devices as well. The implementation of such a system will be well understood by those skilled in the art. The Communication Database 205 (FIG. 2) preferably tracks the type of Communication Event, the data contained in the Communication Event and preferably, a Code Identifier related to the event and the status of the Event. The type of Event usually denotes whether the incoming communication event is a telephone call, a SMS message, an e-mail message, or other data based transactions. It also indicates whether communication was sent by the customer or received by the customer. The data field typically contains the body of the messages exchanged and other related information. Database may also contain corresponding Code Identifiers such as Event ID generated on each Communication Event, Interaction ID generated on creation of an Interaction Thread and a Campaign Step Code associated with each Campaign Step. Upon receipt or delivery of subsequent messages, the message threading is done accordingly. In a presently preferred embodiment, the Communications Events are sorted chronologically so that the newest information is presented at the top of the list.

With reference to the present invention, an ‘Interaction’ is a group of Communication Events such as SMS messages sent/received through the Application Server during a Marketing Campaign. Each time an SMS message is sent/received, a unique Event ID is generated for each such event. An Interaction Thread is created upon receipt of a new Communication Event and a unique Interaction ID is assigned to the Interaction Thread. Upon exchange of every subsequent SMS message between the customer and the organization, the messages are threaded to the corresponding Interaction threads bearing the same Interaction ID. A unique Campaign Step Code is also generated for every new message sent from a particular Campaign. All of these identifier; Event ID, Interaction ID and Campaign Step Code are associated with the Internal ID and saved in the database.

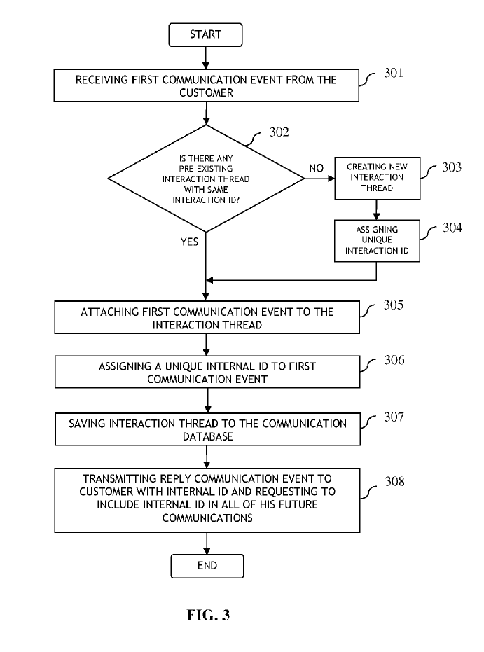

FIG. 3 is a process flow illustrating one approach of processing a communication event when initiated by the customer, in accordance with one embodiment of the present invention. At step 301, first Communication Event (via SMS message, email and the like) from the customer may be received as a response to the Marketing Campaign. Upon receipt of the first Communication Event, an Event ID may be created internally and associated with the Communication Event. At step 302, the information is retrieved from the communication database and it is checked whether there is any pre-existing Interaction Threads belonging to the same Customer. In case there is no pre-existing Interaction thread, a new Interaction thread is created at step 303. The Interaction Thread may have a unique Interaction ID so that all the subsequent communication events sent/received can further be stored in the same Interaction Thread by identifying and matching the Interaction ID from the received or sent communication events. At step 304, the unique Interaction ID is assigned to the interaction thread. If the result of the query at step 302 is affirmative i.e. if there is a pre-existing Interaction Thread with the same Interaction ID, the first communication event is attached to the pre-existing Interaction thread at step 305 and he same step 305 is followed after step 304 as well. At step 305, the first communication event is attached to the Interaction thread created at step 303 or attached to the pre-existing Interaction thread. In the next step 306, a unique Internal ID is generated and assigned to the first communication event. The method may be implemented to gene rate an Internal ID with a specific prefix or suffix. As an example, an Internal ID may consist of a combination of letters (here after called as keyword) describing the type of communication (e.g. interaction, campaign, subscription etc), and combination of numeric letters from 1 to 9 (herein after called as substring encoding details such as Event ID, Interaction ID, Campaign Step Code etc.). As an example, an Internal ID may be TLC12345, wherein TLC is the keyword and 12345 is the substring. This Internal ID is assigned to the first communication event. At step 307, the first communication event is threaded to the Interaction Thread and this Interaction Thread is saved in the Communication Database 205 (FIG. 2). In the next step 308, a reply communication event (i.e. an SMS message) containing Internal ID is further transmitted to the customer. The customer is notified that further responses to this interaction should include the Internal ID containing the specific keyword and substring assigned to him along with the SMS message content. The SMS message text may include a part or whole of the Internal ID prefixed or suffixed with the keyword. The procedure inside the program module identifies the exact Internal ID from the SMS message even if it is not mentioned exactly by the customer.

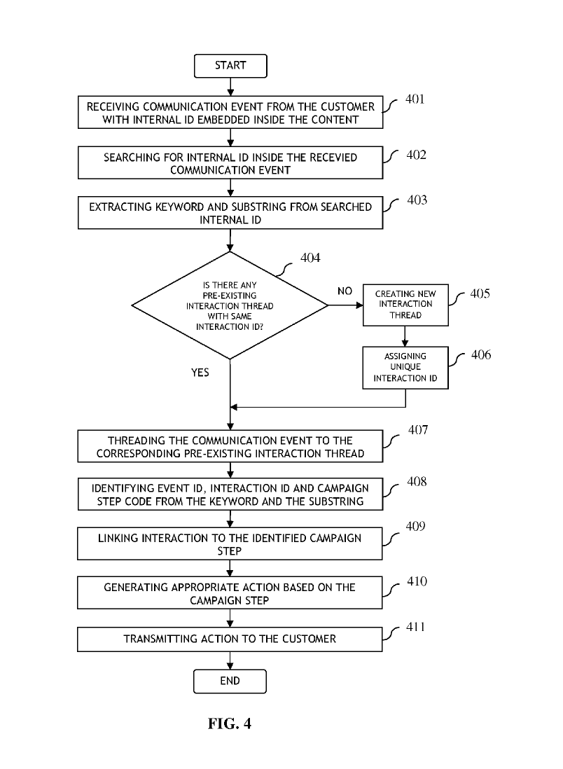

Referring now to FIG. 4 that illustrates the process flow of generating and transmitting appropriate Action, upon receipt of Communication Event from the customer. At step 401, a Communication Event (via SMS message or email) with Internal ID embedded inside the SMS message text is received from the customer. The received SMS message is processed and further sent to the Communication Database 205 (FIG. 2). Since the SMS message text may include a part or whole of the Internal ID prefixed or suffixed with the keyword, the method searches for the Internal ID inside the SMS message text at step 402. As an example, if the Internal ID assigned to the customer is TLC12345 and he replies via SMS message with message text containing TLC345, the stored procedure inside the program module of the invented method returns TLC12345 as an output. At step 403, the keyword and substring are extracted from the identified Internal ID (e.g. in Internal ID TLC12345, keyword is TLC and substring is 12345). The substring may contain information about the Event ID, Interaction ID and Campaign Step Code. After identifying the exact Interaction thread, the method searches for the Interaction Thread belonging to the same Interaction ID in the Communication Database 205 (FIG. 2). At step 404, the information is retrieved from the Communication Database 205 (FIG. 2) and it is checked whether there is any pre-existing Interaction Thread belonging to the same Customer. In case there is no pre-existing Interaction thread, a new Interaction thread is created at step 405. At step 406, the unique Interaction ID is assigned to the Interaction Thread. If the result of the query at step 404 is affirmative i.e. if there is a pre-existing Interaction Thread with the same Interaction ID, the communication event is attached to the pre-existing Interaction thread at step 407 and the same step is followed after step 406 as well. A Campaign may consist of various stages such as sending bulk SMS Messages to send reminders, offers, or some other information, etc. While sending such messages, aunique Campaign Step Code is generated and assigned to each Campaign Step from where the message is sent to the customers and this Campaign Step Code is also attached to the Internal ID and sent to the customer. Upon receipt of an SMS message from the customer, the Campaign Step Code is extracted from the Internal ID inside the SMS message text as described in step 403. At step 408, the invented method identifies and matches the Campaign belonging to the same Campaign Step Code from the Communication Database 205 (FIG. 2). In the next step 409, the massage is linked to the corresponding Step of the Campaign with the same Campaign Step Code. Based on the Campaign Step with respect to which the customer has replied, an appropriate Action is generated by the method and a corresponding Action is performed at 410. The Actions so generated may include; a response to an SMS message, initiate a call, send a reply SMS message, send an Email, move to a different Campaign, set the values for a Property and the like. This acts as a trigger for the SMS message Action in the Campaign Workflow and flows to the next Action in the Campaign based on the Campaign response. In the next step 411, the Action so generated is further transmitted to the customer. Thus the customer receives a prompt and customized reply to his response.

The invention can be implemented in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment

FIG. 5 is a block diagram illustrating an example of suitable computing system environment in which the invented method may be implemented. The computing system environment is only one example of a suitable computing environment and is not intended to suggest any limitation as to the scope of use or functionality of the invention. Neither should the computing system environment be interpreted as having any dependency or requirement relating to any one nor a combination of components illustrated in the exemplary operating environment. Computer Environment includes a general-purpose computing device in the form of a Data Processing System 500, which may be any of computing devices. While the present invention is described hereinafter with particular reference to the system block diagram of FIG. 5 it is to be understood at the outset of the description which follows, it is contemplated that the apparatus and methods in accordance with the present invention may be used with other hardware configurations as well. For example, the system processor could be an Intel Pentium IV at the Server side and Pentium III at the Client's side.

The exemplary CRM application is operational with numerous other general purpose or special purpose computing system environments or configurations. Examples of well known computing systems, environments, and/or configurations that may be suitable for implementation or use include, but are not limited to personal computer, desktop or a server computer, laptops which run on any one of the following operating system Windows Server 2003, Windows XP, Windows Vista. For accessing the CRM application over the web Internet Explorer and Firefox browsers are supported.

Turning now to FIG. 5, a diagram of a design system is depicted in accordance with an illustrative embodiment. In this illustrative example, Data Processing System 500 includes Communications Fabric 504, provides communications between Processor Unit 501, System Memory 502, Storage Media 503, Communications Unit 507, I/O unit 506, and display 505.

Processor Unit 501 serves to execute instructions for software that may be loaded into System Memory 502. Processor unit 501 may be a set of one or more processors or may be a multi-processor core, depending on the particular implementation. The Processing Unit 501 sends various data values, instructions, and information to all the devices and components inside Data Processing System 500 as well as the different peripherals and devices attached.

The System Memory 502 is the place where the computer holds current programs and data that are in use. The System Memory 502 can be divided into two essential types: RAM and ROM. RAM, or Random Access Memory is ‘volatile’ which means that it only holds data while power is present. RAM changes constantly as the system operate, providing the storage for all data required by the operating system and software. ROM or Read Only Memory is always found on motherboards, but is increasingly found on graphics cards and some other expansion cards and peripherals. Instructions for the operating system, the object-oriented programming system, and applications or programs are located on Storage Media 503. These instructions may be loaded into System Memory 502 for execution by Processor Unit 501. The processes of the different embodiments may be performed by Processor Unit 501 using computer implemented instructions, which may be located in the System Memory 502.

Similarly in network environment, program modules depicted relative to Data Processing System 500, or portions thereof, may be stored in a Remote Memory Storage Devices. Various modules and techniques may be described herein in the general context of computer-executable instructions, such as program modules, executed by one or more computers or other devices. An implementation of these modules and techniques may be stored on or transmitted across some form of computer readable media. Storage Media 503 may include removable/non-removable, volatile/non-volatile computer storage media depending upon the particular implementation. For example, Storage Media 503 may be, a hard drive for reading from and writing to a non-removable, non-volatile magnetic media (not shown), magnetic disk drive for reading from and writing to removable, non-volatile magnetic disk (e.g. ‘floppy disk’) and optical disk drive for reading from and/or writing to a removable, non-volatile optical disk drive such as CD-ROM, DVD-ROM, a flash memory, or some combination of the above. The hard disk drive, magnetic disk drive and optical disk drive are each connected to the system bus through one or more data media interface.

Communications Unit 507, in these examples, provides for communications with other data processing systems or devices. In these examples, Communications Unit 507 is a network interface card. I/O Unit 506 allows for input and output of data with other devices that may be connected to Data Processing System 500. For example, I/O Unit 506 may provide a connection for user input though a keyboard and mouse. Further, I/O Unit 506 may send output to a printer. Display 505 provides a mechanism to display information to a user. Data Processing System 500 can be connected to other remote computing devices via network connections constituting a computer network. Remote computing device for example can be a desktop or a server computer, laptops. Remote computing device may include many or all of the elements and features described herein relative to Data Processing System 500. Alternatively, Data Processing System 500 can operate in a non-networked environment as well. Networks connections between the Data Processing System 500 and remote computers may be a local area network (LAN) and a wide area network (WAN). A LAN covers a small geographic area, like a home, office, or building whereas a WAN covers a relatively broad geographic area (i.e. one city to another and one country to another country). In a LAN environment, Data Processing System 500 is connected to local network of computers via network adapter. When implemented in a WAN network environment, Data Processing System 500 includes modem or other means for establishing communications over network. Modem can be internal or external to computer; can be connected to system bus via I/O Unit 506 or other appropriate mechanisms. In some illustrative examples, the Data Processing System 500 may be a Personal Digital Assistant (PDA), which is generally configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main System Memory 502 or cache memory. A Processing Unit may include one or more processors or CPUs. The depicted examples in FIG. 5 and above-described examples are not meant to imply architectural limitations. For example, Data Processing System 500 also may be a tablet computer, laptop computer, or mobile device in addition to taking the form of a PDA.

In operation, Data Processing System 500 executes computer executable instructions such as those illustrated in FIG. 3 and FIG. 4. The order of execution or performance of the methods illustrated and described herein is not essential, unless otherwise specified. That is, elements of the methods may be performed in any order and that the methods may include more or less elements than those disclosed herein. FIG. 5 is intended as an example, and not as an architectural limitation for different embodiments. The hardware in FIG. 5 may vary depending on the implementation. In addition, the processes of the illustrative embodiments may be applied to a multi-processor data processing system.

The description of the illustrative embodiments have been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

### INDUSTRIAL APPLICABILITY

The invented method to generate and transmit an appropriate Action as a response to a Marketing Campaign gives greater flexibility in the automation of Actions that can be modeled within a Campaign Workflow. This helps in achieving a closer integration between SMS Messaging and Marketing Campaigns and have different Workflows based on the response to a specific Campaign Step. By using this invention, an organization can automate a Campaign Action based on the SMS message response and link these responses with the Campaign, which can further be used for Statistical Data Analysis. The invention also gives complete flexibility and automation to an organization running the Marketing Campaign. The Campaigns can be designed for the entire year with automated response management, engagement, offers, call back, follow-up, reminders etc. through a What You See Is What You Get (WYSIWYG) flow chart type of user interface where various flows could be designed in an easy way. Based on the SMS message response, the target contacts could flow through the Campaign Workflow that contains various Action steps. Each step could have an Action based on the response from the customers.

1. A method to generate and transmit appropriate replies for different customers, based on their response to a Marketing Campaign, in a CRM application, the method comprising the steps of:
a) receiving communication event from the customer with Internal ID (internal identifier) embedded inside the content of said communication event;
b) searching for the Internal ID inside the received communication event;
c) extracting keyword and substring from searched Internal ID;
d) threading said communication event to corresponding pre-existing Interaction Thread with same Interaction ID wherein a new Interaction Thread is started, for which there is no pre-existing Interaction Thread with same Interaction ID;
e) identifying Event ID, Interaction ID and Campaign Step Code from said keyword and said substring;
f) linking interaction to identified Campaign Step with respect to which the customer has sent said communication event;
g) generating appropriate Action based on identified campaign step;
h) transmitting said Action to said customer.

2. The method of claim 1, wherein said communication event comprises at least one selected from:
a) email message;
b) short messaging service (SMS) message;
c) instant message.

3. The method of claim 1, wherein said Internal ID further comprises:
a) keyword comprised of one or more letters wherein said keyword contains information about the type of communication event comprising at least one of:
i. interaction;
ii. campaign.
b) substring comprised of one or more numeric characters.

4. The method of claim 3, wherein said substring further comprises:
a) unique Event ID (event identifier) assigned to each communication event;
b) unique Interaction ID (interaction identifier) assigned to each interaction thread;
c) unique Campaign Step Code assigned to each Campaign Step in the campaign workflow, with respect to which a communication event is received.

5. The method of claim 1, wherein the step of identifying corresponding Campaign Step Code further includes matching Campaign Step Code with searched Internal ID.

6. The method of claim 1, wherein each subsequent communication event sent or received, is added to an appropriate Interaction Thread with same Internal ID as that of said communication event.

7. The method of claim 1, wherein appropriate reply action based on said Campaign Step further comprises at least one of:
a) initiating phone call;
b) sending reply SMS message;
c) sending an email message;
d) moving to a different Campaign;
e) sending instant message;
f) sending embedded advertisement.

8. A computer program product comprising executable instructions that, when executed cause a computing system to perform the method as in claim 1.

9. A customer relationship management system comprising:
a) centralised customer database configured to store customer data wherein said customer data comprises name, organization, phone number, email ID, address and the information associated with the customer;
b) centralised communication database interlinked with said customer database wherein:
i. said communication database is configured to store all said interaction threads containing said communication events sent or received;
ii. said communication database comprises all communication events sent or received;
iii. said customer database and said communication database, both are stored in said centralised application server.
c) marketing campaign module configured to:
i. analyse the communication events; and
ii. based on the analysis, generate appropriate actions while running the campaign.
d) a user interface window on a CRM application, displaying said marketing campaign module in graphical form.

10. The customer relationship management system of claim 9, wherein said marketing campaign workflow further comprises a graphical workflow wherein pre-determined actions are generated automatically by said customer relationship management system, depending upon the response from the customer.
